(19) United States
(12) Patent Application Publication
(10) Pub. No.: US 2005/0033652 A1
(43) Pub. Date: Feb. 10, 2005

(54) Method and system for managing digital goods

(76) Inventors: James Brentano, Orinda, CA (US); Toby Pieper, Orinda, CA (US); Paul Martinelli, Berkeley, CA (US); Brad Thompson, Danville, CA (US); Richard Northing, Alamo, CA (US)

Correspondence Address: GLENN PATENT GROUP, 3475 EDISON WAY, SUITE L, MENLO PARK, CA, 94025, US

(21) Appl. No.: 10/635,840

(22) Filed: Aug. 5, 2003

(51) Int. Cl. G06F 17/60

(52) U.S. Cl. 705/26

(57) ABSTRACT

A method and system for management of digital goods is provided that allows digital goods vendors to model and manage complex product relationships involved in electronic distribution of digital goods, such as software. A variety of interactive tools to define associations among a variety of primary objects are provided that allow a vendor to create a product hierarchy that mirrors the marketing descriptions and organization of the vendor's product set. The various products are uploaded to a server for electronic distribution to end-users. A system operator implements the system across a publicly accessible network such as the Internet. The system operator, typically on a subscription basis, hosts each digital goods vendor. Each subscribing digital goods vendor provides each of their customer accounts a personalized software maintenance portal branded to the vendor that integrates with vendor's web site.

### BACKGROUND OF THE INVENTION

1. Field of the Invention

The invention relates generally to electronic distribution of digital goods. More particularly, the invention relates to methods for managing complex product relationships involved in distribution of digital goods.

2. Technical Background

Digital delivery has emerged as an efficient and profitable method of distributing digital goods such as software. While some suppliers of digital goods offer simple downloads from their web sites, these services provide only limited value to the supplier and the supplier's customers. There is a growing demand from end-users for increased services and from suppliers for better management and control of the complete delivery process. Increasingly, digital goods involve frequent updates, bug fixes, patches, and release notifications, resulting in exceedingly complex product relationships. Modeling/representing and managing these complex relationships poses a formidable challenge to digital goods suppliers.

K. Milsted, C. Kindell, Q. Qong, Automated method and apparatus to package digital content for electronic distribution using the identity of the source content, U.S. Pat. No. 6,345,256 (Feb. 5, 2002) describe a system and related tools for secure delivery and rights management of digital assets. While Milsted, et al. appear to recognize the complex product relationships associated with digital goods, they propose no solutions for modeling and managing the relationships, focusing instead on secure delivery and rights management.

W. Foster, C. Tselebis, Method, apparatus and system for merchandising related applications, U.S. Pat. No. 6,493,678 (Dec. 10, 2002) describe a system and method for organizing product line data, including product hierarchies and time horizons, for use across a variety of distribution channels. While the Foster teachings recognize the importance of managing product data, the solution they provide is essentially a streamlined method of producing a static, non-interactive product line document. The system lacks the capability of interactively distributing actual product to the customer or end-user according to associated entitlements or orders.

J. Ogilvie, Automatic broker tools and techniques, U.S. Pat. No. 6,547,134 (Apr. 15, 2003) describes methods and systems for facilitating electronic commerce in digital goods, such as digitized musical works, software or electronic documents. While the Ogilvie teachings are related to distribution of digital goods, they concern themselves primarily with successful completion of transactions for the sale of digital goods in which buyer and seller are satisfied with the end result. Complex product relationships or the importance of modeling and managing them are not recognized.

R. Reisman, Method and system for distributing updates by presenting directory of software available for user installation that is not already installed on user station, U.S. Pat. No. 6,557,054 (Apr. 29, 2003) provides a method and corresponding system for distributing updates for a plurality of different products to a plurality of uncoordinated user stations via a non-proprietary network. The central element of the described system consists of a software object, essentially a file transfer application, residing on each user station that establishes communication with a server to download updates of information products installed on the user station. A user interface is provided so that the user may view a directory of items available on the server and select from among the items available. Alternatively, examination of the directory and download may be automated. While Reisman provides a system that simplifies the process of locating and downloading digital goods, even recognizing the complex product relationships involved in distribution of digital goods, little attention is paid to methods for managing and modeling the relationships, or management of entitlements to the goods themselves.

There exists, therefore, a need in the art for a method and system of managing digital goods that would allow vendors to model and manage the complex product relationships typically involved with distribution of digital goods, particularly as related to electronic distribution of digital goods. It would be a great advantage to represent products as a set of relationships or associations between objects to which end users can be entitled, objects that can be delivered and objects that can be downloaded. It would be a further advantage to provide a model and tools with which the associations can be defined and managed.

### SUMMARY OF THE INVENTION

The invention provides a method and system for management of digital goods. The invention is particularly suited for modeling and managing complex product relationships necessitated by fixed-duration, subscription, or contract-based electronic distribution of digital goods, among them software products and other digital products such as e-books and digitized images. Using a variety of interactive tools provided by the invention, the digital goods vendor creates a product hierarchy based on associations, or relationships among a collection of primary objects. One embodiment of the invention includes one or more of the following objects:
Entitlements: equivalent to an order, subscription, or contract, grants an end user customer access to a vendor's digital goods. ‘Entitlements’ also specify such terms as account, quantity and effective date. An ‘Entitlement’ is typically associated with one or more ‘Catalog items’;
Catalog items: equivalent to price list items, represent each of a vendor's individual products, for example a product or a maintenance agreement. A ‘Catalog item’ is typically associated with one or more ‘Products’;
Products: equivalent to a product release, represent actual deliverables, for example, a specific version of a product. A ‘Product’ is typically associated with one or more ‘Files’; and
Files: ‘Files’ include the actual data objects that the end user downloads, for example, the installation executable for a particular platform.

Ideally, the resulting product hierarchy mirrors the marketing descriptions and organization of the vendor's product set. After the hierarchy is created, the vendor, again by way of interactive tools provided by the invention, uploads the individual files that make up the various ‘Products’ for download by end users, typically customers of the digital goods vendor.

In a preferred embodiment, a system operator implements the invention across a publicly accessible network such as the Internet. Each digital goods vendor is hosted by the system operator, typically on a subscription basis. Using the invention, each subscribing digital goods vendor is able to provide each of their customer accounts a personalized software maintenance portal that may be branded to the vendor, integrating seamlessly with any other of the vendor's network presences, for example, a web site.

### BRIEF DESCRIPTION OF THE DRAWINGS

FIG. 1 provides a data flow diagram in a system for managing digital goods according to the invention;

FIG. 2 shows a user interface for searching Entitlements from the system of FIG. 1 according to the invention;

FIG. 3 shows a user interface for selecting an account to entitle from the system of FIG. 1 according to the invention;

FIG. 4 shows a user interface for viewing entitlements from the system of FIG. 1 according to the invention;

FIGS. 5a and 5b show a user interface for creating and editing entitlements from the system of FIG. 1 according to the invention;

FIG. 6 shows a user interface for searching Catalog Items from the system of FIG. 1 according to the invention;

FIG. 7 shows a user interface for viewing Catalog Items from the system of FIG. 1 according to the invention;

FIG. 8 shows a user interface for creating and editing Catalog Items from the system of FIG. 1 according to the invention;

FIG. 9 shows a user interface for searching Products from the system of FIG. 1 according to the invention;

FIG. 10 shows a user interface for viewing Products from the system of FIG. 1 according to the invention;

FIGS. 11a and 11b show a user interface for creating and editing Products from the system of FIG. 1 according to the invention;

FIG. 12 shows a user interface for searching Files from the system of FIG. 1 according to the invention;

FIG. 13 shows a user interface for viewing Files from the system of FIG. 1 according to the invention;

FIG. 14 shows a user interface for creating and editing Files from the system of FIG. 1 according to the invention;

FIG. 15 provides a diagram of a Catalog Item level from a product hierarchy in the system of FIG. 1 according to the invention;

FIG. 16 provides a diagram of a Product level from a product hierarchy in the system of FIG. 1 according to the invention;

FIG. 17 provides a diagram of a File level from the product hierarchy in the system of FIG. 1 according to the invention;

FIG. 18 diagrams a product hierarchy for managing subscription and non-subscription catalog items according to the invention; and

FIG. 19 provides a flow chart for date management of products according to the invention.

### DETAILED DESCRIPTION

The System

The invention provides a hosted, network-based delivery and support solution that enables vendors of digital goods to easily deliver, track and manage the digital goods and entitlements that the vendors distribute to their global customers. Advantageously, the solution is rapidly implemented and seamlessly integrated into a customized web site, and supports any e-commerce, direct, or channel sales model. The invention finds particular application in electronic distribution of digital goods such as software.

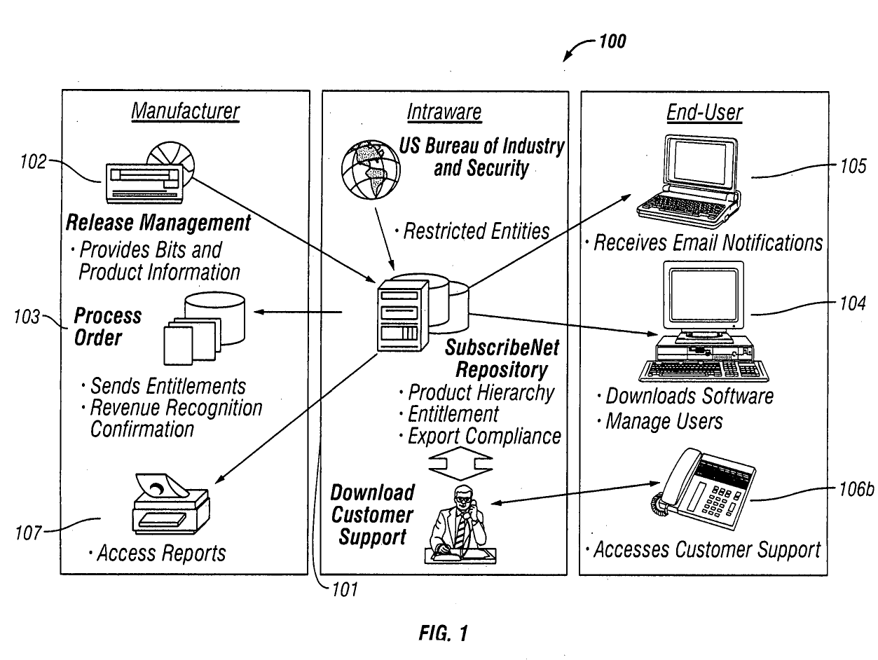

FIG. 1 provides a diagram of a system for managing digital goods 100. The system may be implemented across a publicly accessible network, such as the Internet. Data flow within the invented system is also shown. The invented system is built around a repository 101, the repository including one or more servers and associated mass storage that store a copy of a vendor's product, documentation, release notes and any other related material. These are typically provided by the vendor 102 as part of the original implementation of the product management and distribution service provided through the system. Subsequently, the materials are refreshed as products are updated. The system also associates each downloadable file (image) with one or more vendor part numbers. Typically, the system operator makes the system available to vendors on a subscription, or fee basis; however, other business models are possible

Once the images are loaded into the system, and the part numbers created, the system is ready to process orders 103 and deliver the digital goods, for example, software, to the vendor's customers 104. This ‘entitlement’ process typically happens with, for example, an XML-based data feed that originates with the vendor's order management or ERP (enterprise resource planning) system. The data feed specifies which customers are being entitled to which part numbers, and under what license and maintenance terms. The entitlement data feed may also contain other vendor-specific information, such as license keys and support codes. Other methods of transmitting order information to the system may be envisioned by one having an ordinary level of skill and are well within the scope of the invention.

The system processes the data feed and creates user accounts, if necessary, and the entitlements that allow the customer to see and download the appropriate images when they log into the service web site. The system also associates all the vendor and customer specific information with the vendor part numbers so that they are available at the time of delivery.

The system then generates e-mail messages 105 to designated contacts within the customer account to notify them that their software is available. The email may include a unique URL that gives the customer access to his or her own dynamically generated, and password-protected web site, thus providing the customer a personalized, digital goods management portal. The web site may be branded to the vendor, having the same look and feel as the rest of the vendor's web site. Through this personalized web site, the customer gains ready access to any digital goods the customer is entitled to, as well as any related documentation, access keys, release notes, and contact information, not only for the current order, but also for any previous releases to which that customer is entitled.

The system can also be configured so that when the customer first attempts to download a particular product, the customer is required to read and to accept online end-user license agreement (EULA). A reporting function 107 delivers regular reports to the vendor, allowing the vendor to closely monitor activities from all of the vendor's customer accounts.

Managing Entitlements

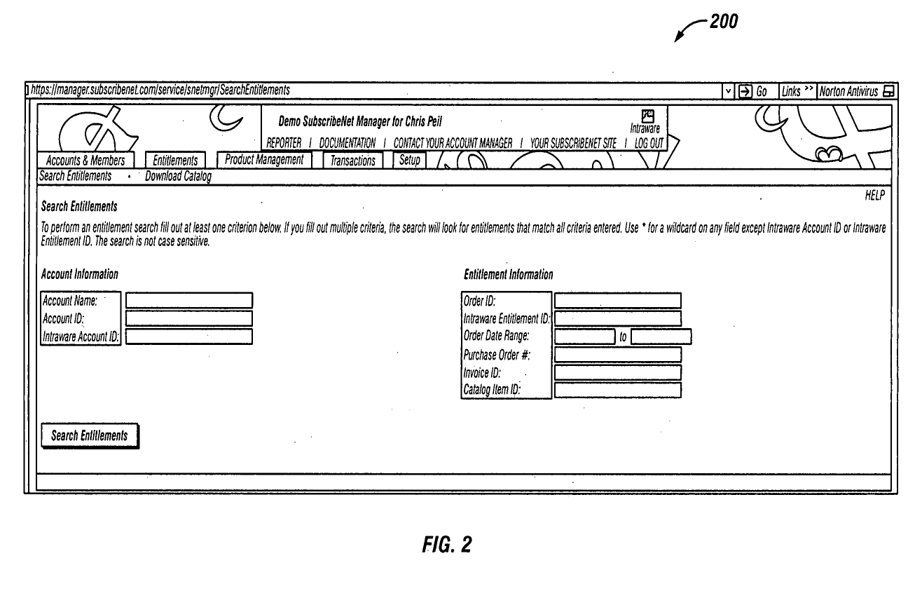

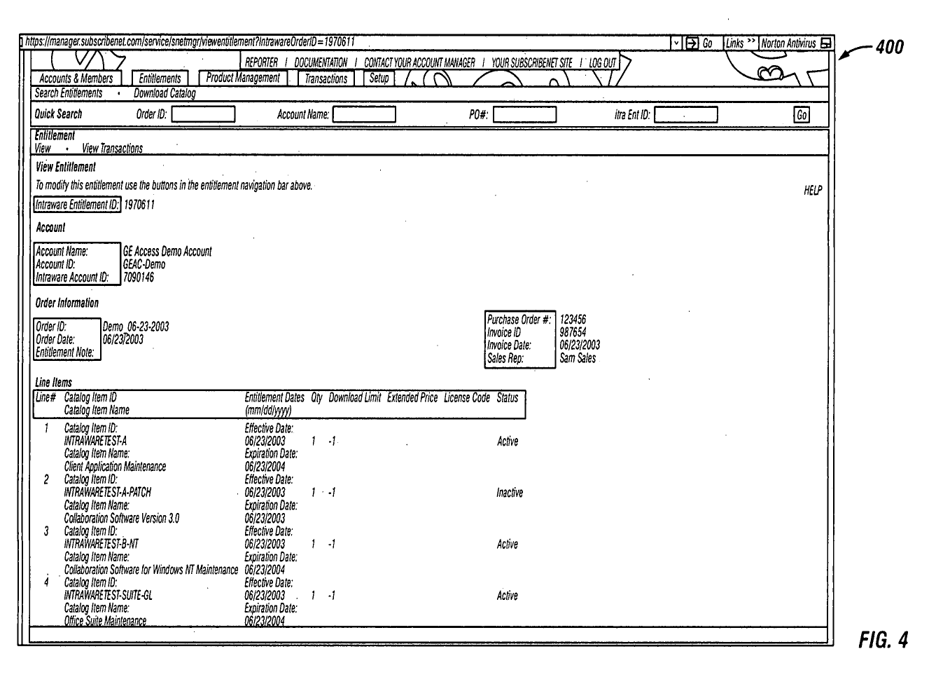

As previously described, entitlement is the process of matching customers with the product(s) that they have purchased, and granting them access to the product(s). Accordingly, an entitlement may be seen as being the equivalent of an order, but may also be used to grant direct access to software without an order. FIGS. 2 through 5 provide screenshots of user interfaces for managing entitlements

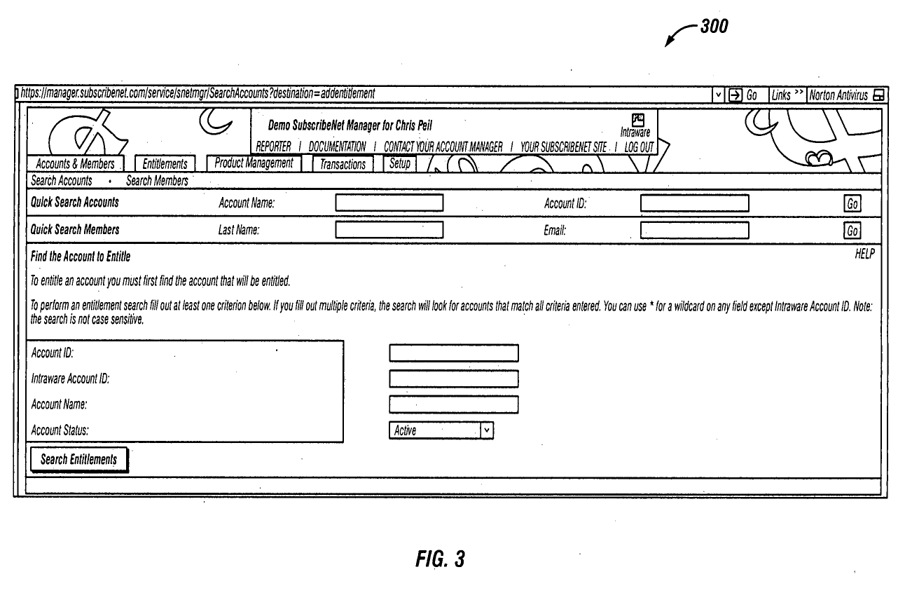

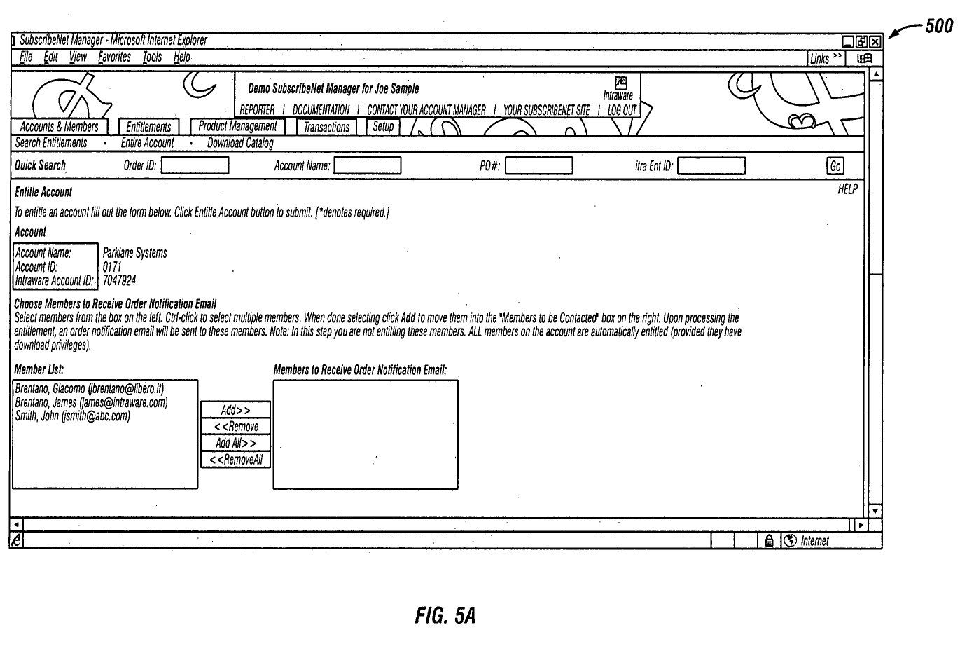

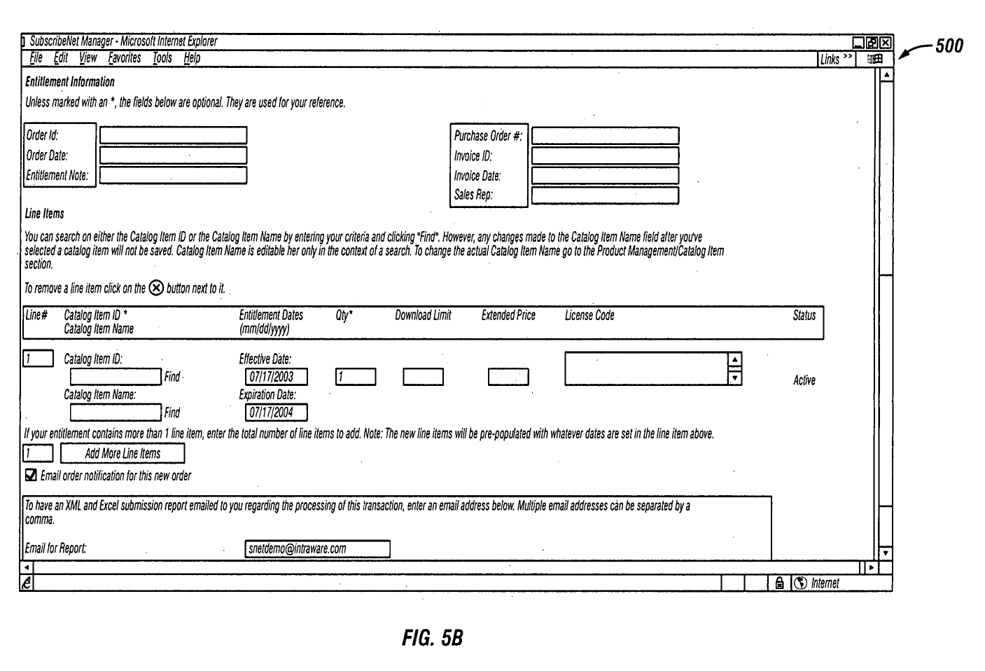

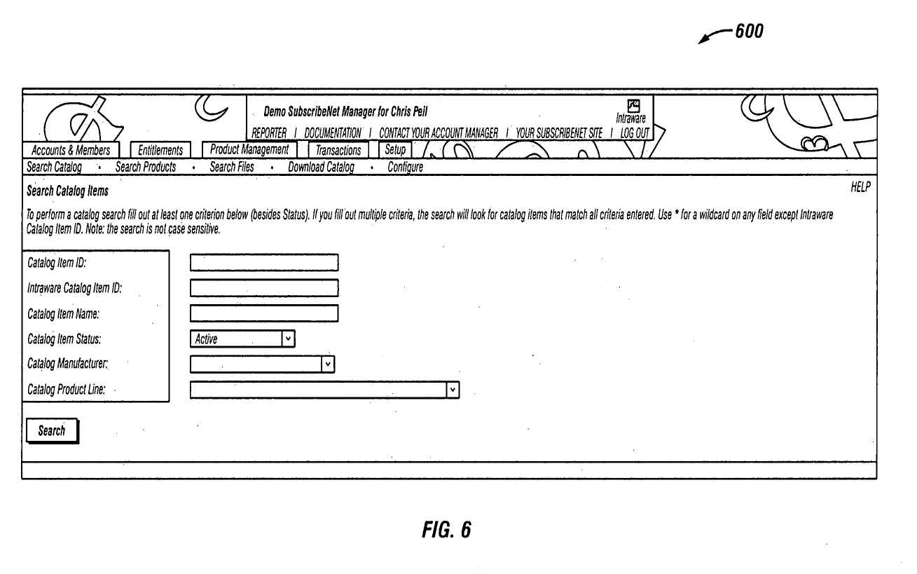

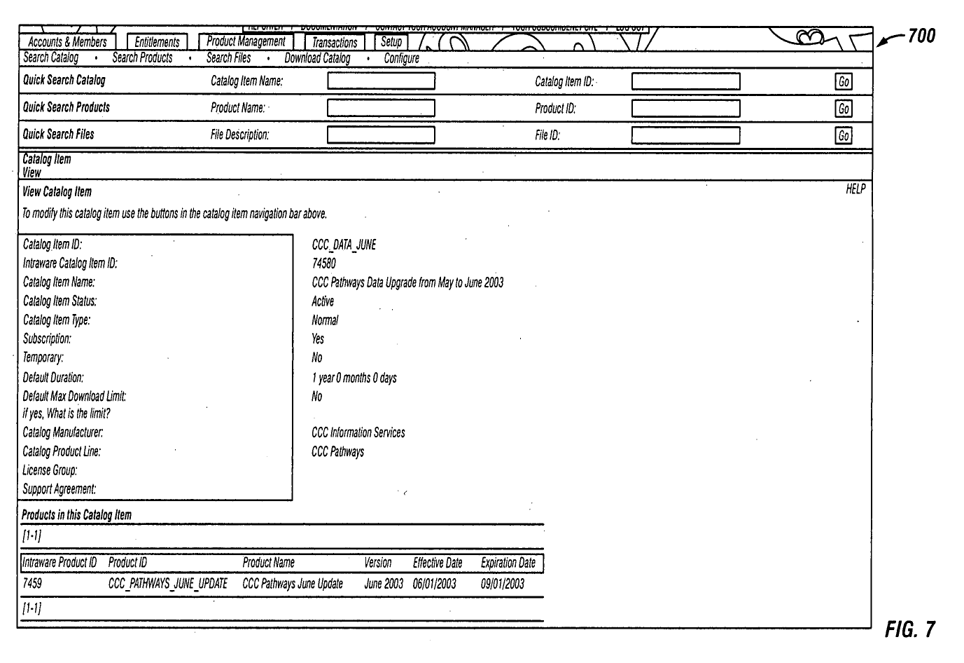

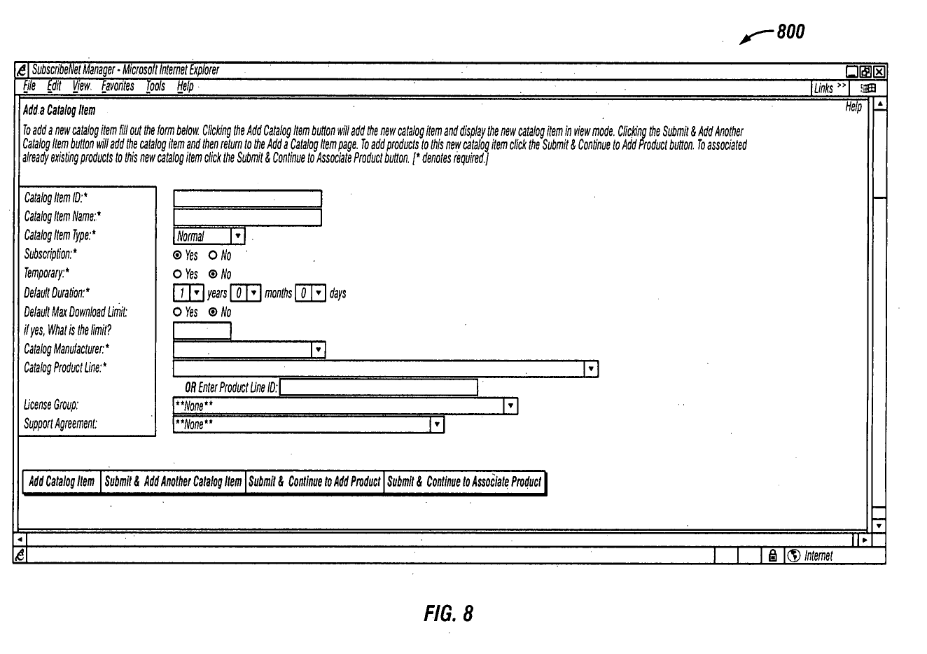

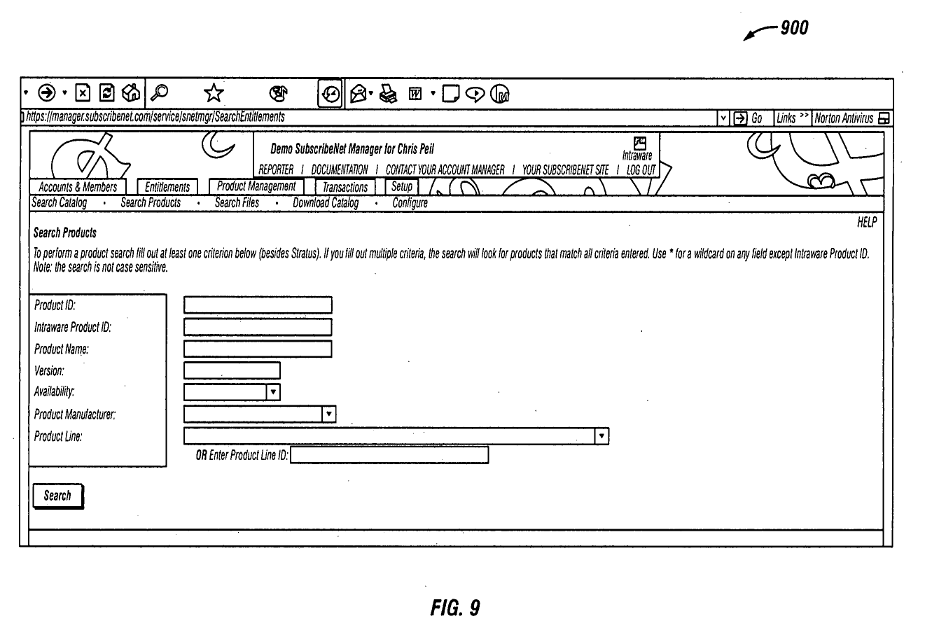

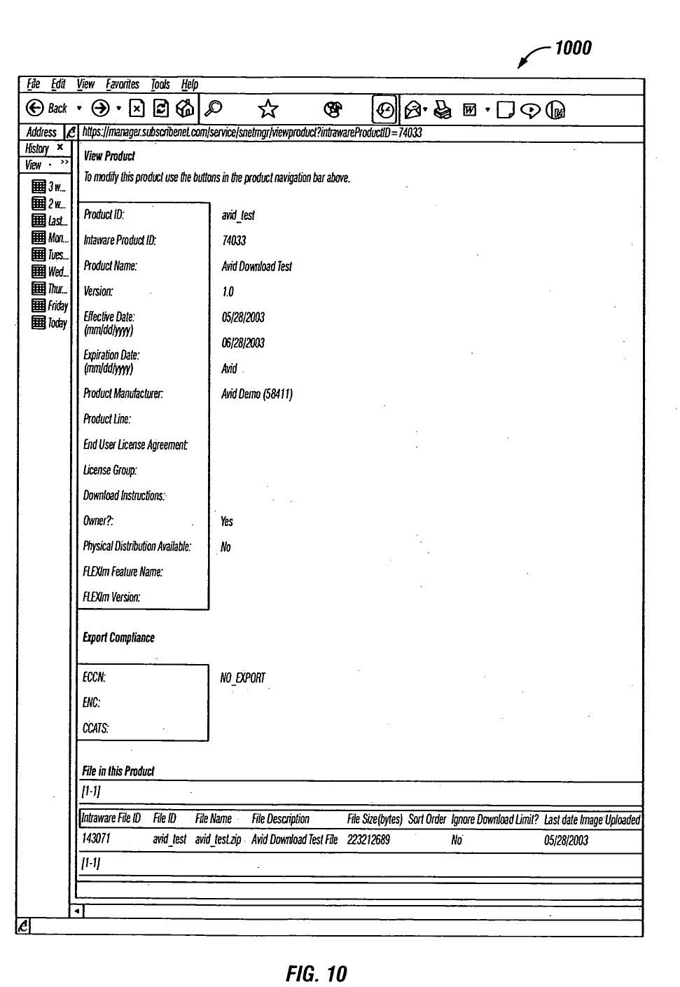

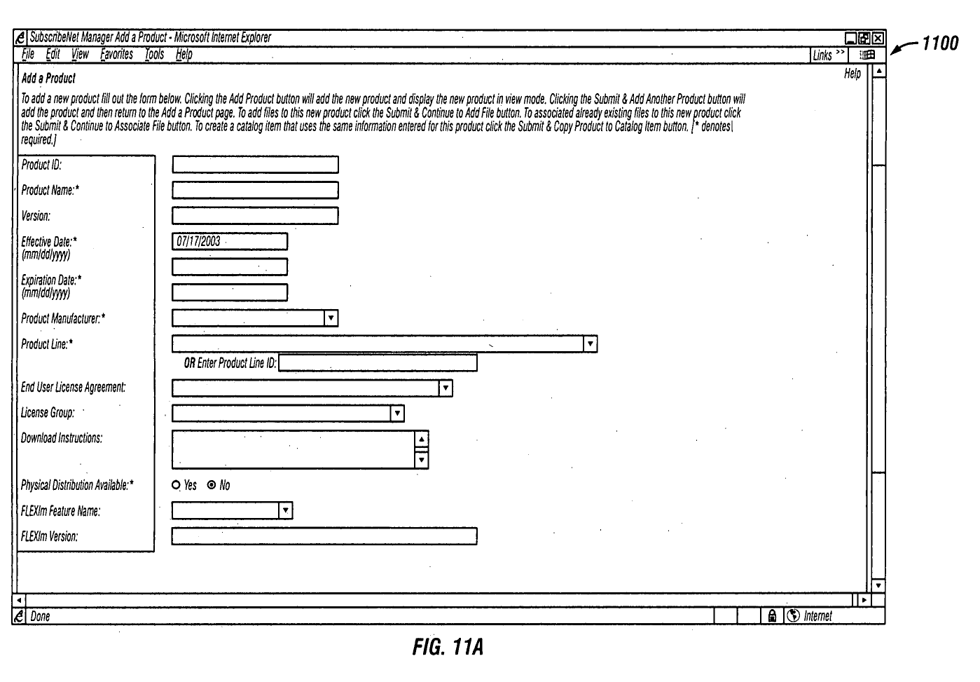

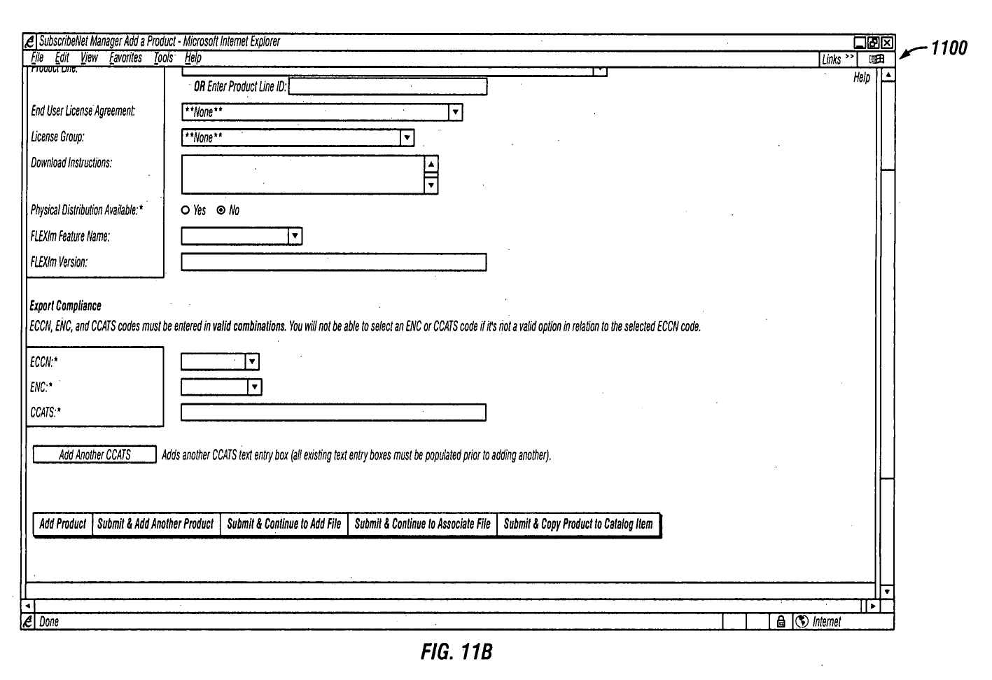

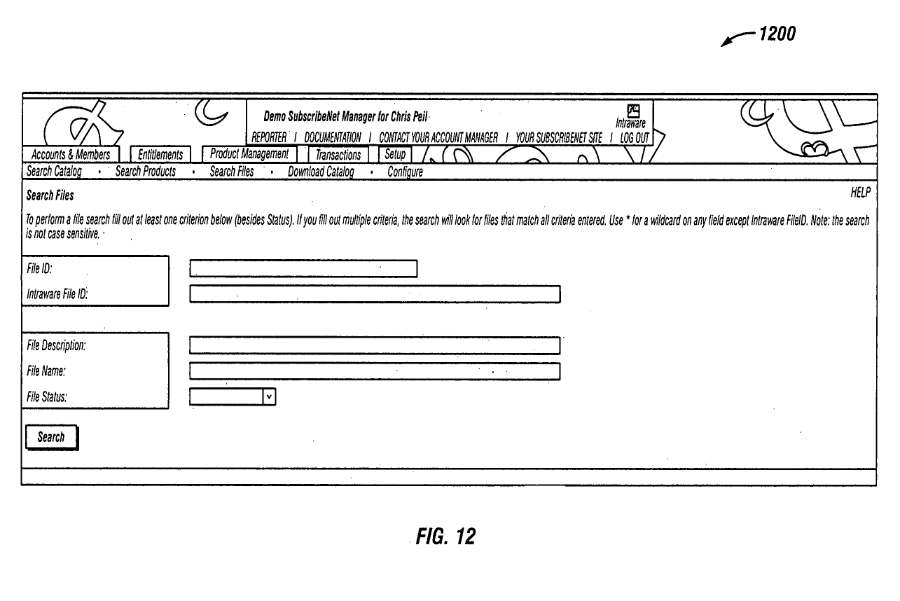

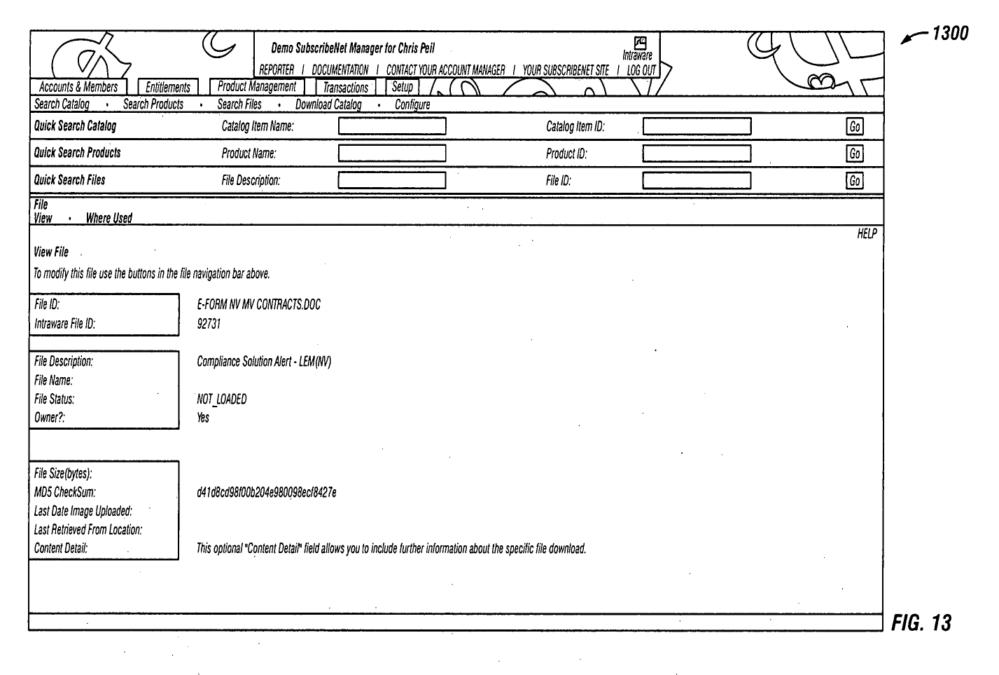

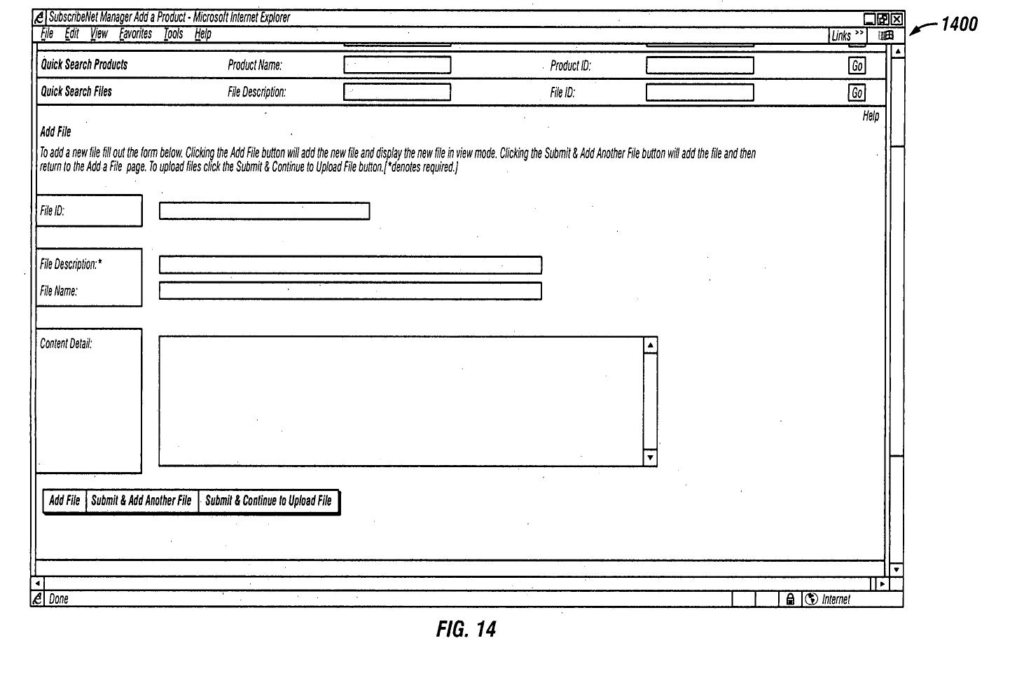

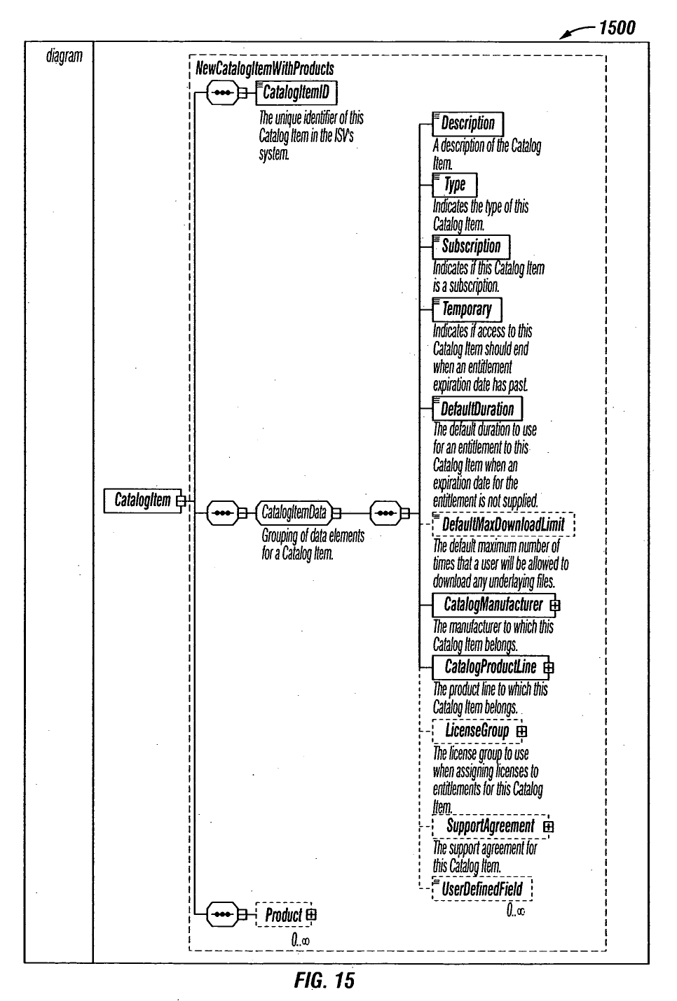

By means of the user interfaces for managing entitlements, a vendor is able to view, create and/or edit entitlements. Entitlement management initially involves searching for and selecting an existing entitlement (FIG. 2), or by creating a new one (FIG. 5). Because entitlements are granted to accounts, the vendor must first select an account (FIG. 3) or create a new one (not shown).

Entitlement management includes the following options:

Search Entitlements—the user interface 200 for searching Entitlements provides the following search criteria:
Account name;
Account ID;
System Account ID;
Order ID;
System Entitlement ID;
Order date range;
Purchase order no.;
Invoice ID; and
Catalog Item ID (described below).

View Entitlements—The ‘View Entitlement’ screen 400 is accessed either by searching for and selecting an existing Entitlement or by creating a new Entitlement Item. The ‘View Entitlement’ screen displays the current values for Entitlement attributes. This screen also shows the Catalog Items associated with this Entitlement. Clicking on a Catalog Item navigates the user to that Catalog item's ‘View Catalog Item’ page.

Entitle Account—Because entitlements are granted to accounts, the system provides a means of locating the account to be entitled, using the ‘Find account’ user interface 300, shown in FIG. 3. When the desired account is located, the actual entitlement is added, wherein the products the account needs to be entitled to are specified. Definition of the entitlement is accomplished using the user interface for creating and editing entitlements 500 as shown in FIGS. 5a and 5b. Vendor definable Entitlement attributes include:
Account name;
AccountID;
System Account ID;
OrderID;
System Entitlement ID;
Order date;
Effective date;
Expiration date;
Purchase order no.;
Invoice ID;
Invoice date;
Sales rep;
Catalog Item ID (described below).
Quantity;
Download limit;
Extended price;
License group; and
Status.
   Product Management

Using the product management interface, new product information can be added, or products that are already in the system can be edited or updated, and the corresponding downloadable files added. The invention permits product information to be organized as a multi-level hierarchy. The product management interface allows the vendor to create a variety of objects, each type of object corresponding to a level in the product hierarchy. The product management interface is currently instantiated as both a web based interactive user interface and as a programmatic XML-based interface. One skilled in the art can easily envision additional representations for this functionality. In the current embodiment, products are managed using at least three different levels: Catalog Item, Product, and File. Thus, there exist the following corresponding object types:
Catalog Items (price list items) represent a vendor's discrete product offerings; for example, a product or a maintenance agreement. ‘Catalog Items’ generally are associated with one or more ‘Products’.
Products (product releases) represent the things that the vendor wants delivered, for example, a specific version of a product. ‘Products’ reference one or more ‘Files’.
Files (images) are the actual software files that the end user downloads, for example, the installation executable for a particular platform. A ‘File’ may be associated with one or more ‘Products’.

The invention provides vendor definable-objects for each level of the hierarchy. Attributes for each object are defined by means of the product management interface.

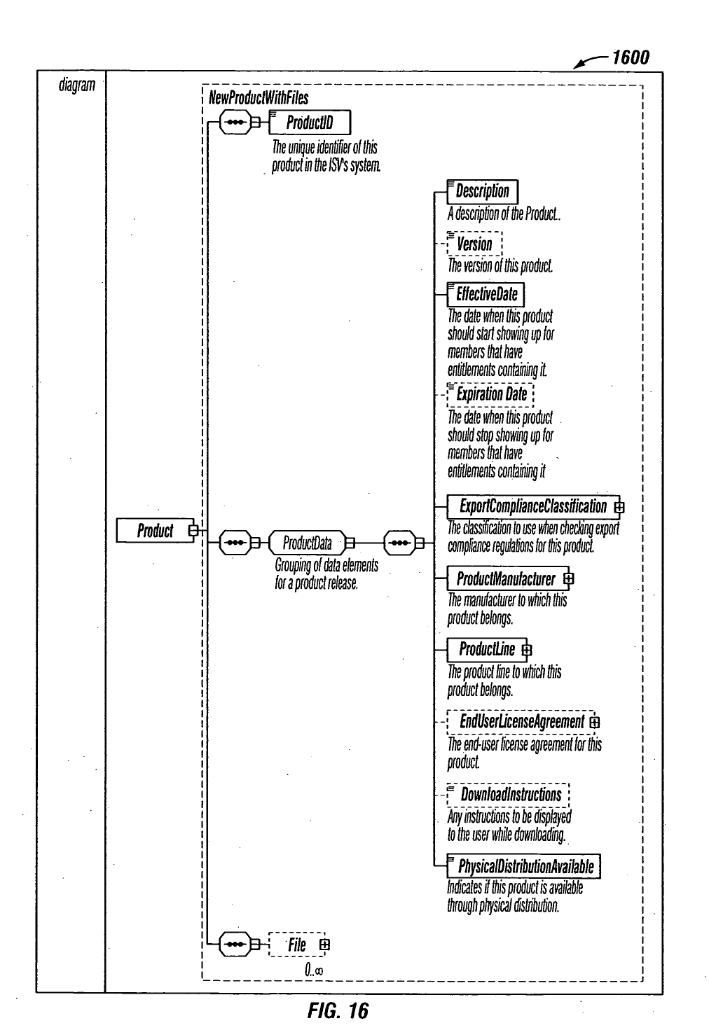

Catalog Item (FIG. 16)

Editing or Updating a Catalog Item

The invention includes a search Catalog Item user interface 600 that allows a vendor to locate a Catalog Item using a variety of search criteria. If the search criteria match more than one ‘Catalog Item’, the searcher is presented with a selectable list of Catalog Items satisfying the search criteria.

Possible search criteria include:
Catalog Item ID;
System ID;
Catalog Item description;
Catalog Manufacturer;
Catalog product line; and
Status, i.e. ‘active’ or ‘inactive’.

Upon selecting a Catalog Item, the selected Catalog Item is displayed in the view Catalog Item user interface 700.

Having searched for and selected a Catalog Item, the vendor may:
Update the item;
Add or delete Products from the Catalog Item;
Re-identify the Catalog Item;
Inactivate/Reactivate the Catalog Item; and
Copy the Catalog item to create new object.

Editing or updating a Catalog Item is by way of the user interface for creating and editing Catalog Items 800.

Creating a Catalog Item

A ‘Catalog Item’ may include any or all or the following vendor-definable attributes:
Catalog Item ID—the unique identifier for the particular Catalog Item in the vendor's system, for example a sale catalog or price list ID;
Catalog Item Description—a brief description of the particular Catalog Item;
Type—possible values: ‘normal’, ‘report only’, ‘ignore SKU’. Can be used to inform the system not to process orders for the Catalog item. Most catalog items would be of ‘normal’ type, but a service agreement would not involve a deliverable product;
Subscription—Yes/No, defaults to ‘Yes’: indicates whether or not the particular Catalog Item is a subscription;
Temporary—Yes/No, defaults to ‘No’: indicates whether or not access to the particular Catalog Item should end when an entitlement expiration date has passed;
Default Duration—defines the default duration to use for an entitlement to the particular Catalog Item;
Download limit—(Yes/No), defaults to ‘No’. If ‘Yes’ is selected, the files associated with Products that are entitled through this Catalog Item may only b e downloaded a limited number of times, specified by Default Maximum Download Limit;
Default Maximum Download Limit—the default maximum number of times that a user will be allowed to download any files associated with the particular Catalog Item;
Catalog Manufacturer—List of configured companies or product groups.

Manufacturer is configured via the “Configuration” menu, described below;
Catalog Product Line—the manufacturer to which the particular Catalog Item belongs;
License Group—the license group to use when assigning licenses to entitlements to the particular Catalog Item. License groups are configured at the time of site creation;
Support Agreement—the support agreement for the particular Catalog Item; and
Restricted Certificate (Yes/No)—defaults to ‘No’. If set to ‘Yes’, then only users specifically named on an Entitlement will have access to the products entitled through the particular Catalog Item.

In addition to the vendor-supplied Catalog Item ID, each Catalog Item is assigned a unique system ID at time of creation. Creation of a new Catalog Item is by way of the user interface 800.

As shown in FIG. 16, a ‘Catalog Item’ is associated with one or more ‘Products’. It will be apparent to one skilled in the art, that the definition of a particular ‘Catalog Item’ may not require the vendor to define all of the attributes listed above.

Provided herein below is a more detailed description of Catalog Item operations:

View Catalog Item

The ‘View Catalog Item’ screen 700 is accessed either by searching for and selecting an existing Catalog Item or by creating a new Catalog Item. The ‘View Catalog Item’ screen displays the current values for Catalog Item attributes. This screen also shows the Products associated with this ‘Catalog Item’. Clicking on a Product Description navigates the user to that Product's ‘View Product’ page.

Update Catalog Item

The ‘Update Catalog Item’ form 800 is used to edit any of the catalog attributes except the ‘Catalog Item’ ID. All existing entitlements based on the Catalog Item remain in place but will reflect the new Catalog Item attributes in the reporting feature and wherever displayed on the system site. Changing the Catalog Item ID requires use of the ‘re-identify’ feature.

Add/Delete Products to/from Catalog Item

To Add or Delete Products from a Catalog Item, it must first be identified either by searching for and selecting an existing ‘Catalog Item’, or by creating a new Catalog Item. The ‘Add/Delete Products’ feature lists any Products currently associated with the particular Catalog Item. Selecting a ‘delete’ checkbox next to the product and submitting the deletions deletes the selected Products from the Catalog Item.

To associate existing Product(s) to the Catalog Item, Choose ‘Associate Product’ from the menu. Search for the Product(s). All matching Products will be displayed. Select the one(s) to associate to the ‘Catalog Item’ and dick the submit button. The Product(s) selected are added to the list of ‘Products in this Catalog Item.’

Re-Identify Catalog Item

The Re-identify feature is used to change the Catalog Item ID. All existing entitlements based on the Catalog Item remain in place but reflect the new Catalog Item ID in the system reporter and wherever displayed on the system site.

Inactivate/Reactivate Catalog Item

Selecting ‘Inactivate’ or ‘Reactivate’ from the Catalog Menu changes the status of the particular Catalog Item. When ‘Inactivate’ is selected, the Catalog Item's status changes to ‘Expired’. New entitlements cannot be processed for expired ‘Catalog Item’s but existing entitlements are not affected. Inactive ‘Catalog Item’s can be restored to active status by selecting “Reactivate” from the ‘Catalog Item’ menu.

A ‘Copy Catalog Item’ function is used to create a new Catalog Item that is very similar to an existing one. The ‘Copy’ function will take all of the attribute values of the original Catalog Item and copy them into the corresponding fields of a new ‘Add Catalog Item’ form. One can then make any changes necessary to distinguish the new Catalog Item from the original and then save the new Catalog Item.

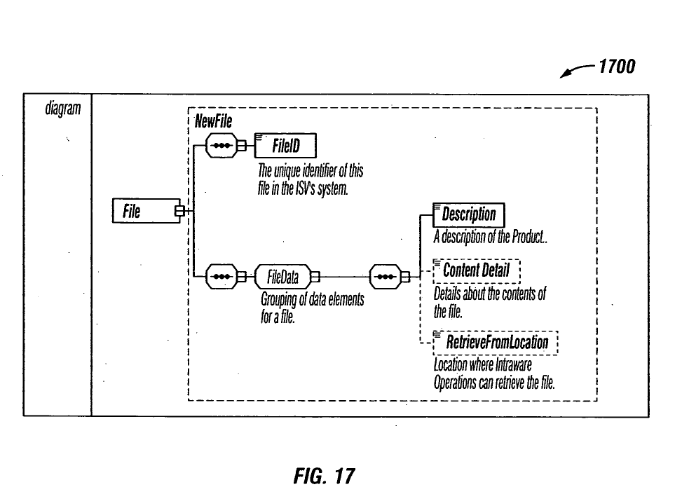

Product (FIG. 17)

Editing or Updating a Product

Products are also searchable by way of the ‘Search Products’ user interface 900 in a manner similar to that previously described for Catalog Items.

Possible search criteria include:
Product ID;
System ID;
Product description;
Product Manufacturer;
Product line; and
Status.

As with Catalog Items, after a Product is selected, it is displayed by way of the view Product user interface 1000. Having searched for and selected a Product, the vendor may:
Update the item;
Add or delete Files to/from from the Product;
Re-identify the Product;
Inactivate/Reactivate the Catalog Item;
Find all Catalog Items that include the particular Product;
Copy Product information as a short-cut to making a new Product having similar characteristics;
Add the particular Product to a selected Catalog Item, or Items; and

Instruct the system to use the particular Product in all Catalog Items where some other product is used, for example, instructing the system of use version 2.1.1 wherever version 2.1 is found; and
Send email notification to users who have entitlements which include this Product

The vendor can also create a Catalog Item based on the Product; that is, a Catalog Item having the same ID, Description, Product Line, and so on. Selecting this option navigates the Vendor to a ‘Create Catalog Item’ form that has been pre-populated with the attributes from the Product. When the new Catalog Item is saved, the Product will already be associated with it.

Creating a Product

A Product constitutes a logical description of one or more downloadable files, often bundled together as a release. Such deliverable products are associated with one or more Catalog Items that have been previously configured, and through which the Product is entitled. New Products may be created, or existing ones edited by way of a user interface for creating and editing Products 1100. A Product may include any or all of the following vendor-definable attributes:
Product ID—the unique identifier for the particular Product in the vendor's system;
Description—a description of the particular Product, preferably a user— friendly name for the product. The product description is displayed and used as a landmark when navigating the vendor's web site;
Product Version—typically a numerical or textual designator;
Available Date—the date when the particular Product should start showing up for members that have entitlements containing it;
Archive Date—Once this date has passed the product/version is no longer actively displayed, but is accessible by selecting an ‘Archive’ tab from the end user interface;
BIS (Bureau of Industry and Standards) classification—includes ECCN (EXPORT CONTROL CLASSIFICATION NUMBER), ENC (ENCRYPTION COMMODITIES AND SOFTWARE), and CCATS (COMMODITY CLASSIFICATION AUTOMATIC TRACKING SYSTEM) codes; specifies the product's encryption levels and export licenses, allowing the product to be distributed worldwide;
Product manufacturer—A list of configured companies or product groups, Manufacturer is configured via the “Configuration” menu
Product line—Product Line is configured via the “Configuration” menu;
End user license agreement (EULA)—A list of configured click-through agreements that may be associated with a Catalog Item. EULA's are configured through the ‘Configuration’ menu.
Product Note—Supplemental information for the end user, the Product Note is displayed on the Product Download page of the vendor's web site.

Physical distribution available—indicates whether or not the particular Product is available through physical distribution in addition to electronic delivery; and
Send Update Notification (Y/N)— configurable from a separate screen.

In addition to the vendor-supplied Product ID, each Product is assigned a unique system ID at time of creation.

As shown in FIG. 16, a Product is associated with one or more Files. It will be apparent to one skilled in the art that the definition of a particular Product may not require the vendor to define all of the attributes listed above.

Provided herein below is a more detailed description of Product operations:

View Product

The ‘View Produc’ screen is accessed either by searching for and selecting an existing Product 900 or by creating a new Product 1100. The ‘View Product’ screen 1000 displays the current values for the particular Product's attributes. This screen also shows the Files associated with the particular Product. Clicking on a File Description navigates the user to that File's ‘View File’ page.

Update Product

Once a Product has been selected, the vendor can dick on ‘Update’ to edit and update the Product attributes. The Update Product form behaves much like the Create Product form and allows the vendor to modify all of the product information except the ‘Product ID’. If the vendor needs to change the ‘Product ID’, they must use the ‘Re-identify Product’ feature.

Add/Delete File

To add or delete Files from a Product, the vendor must first identify the Product either by searching for and selecting an existing Product, or by creating a new Product. The Add/Delete Files form lists any Files currently associated with this Product. To delete one or more of these Files, the vendor must dick on a ‘delete’ checkbox next to the item(s) and then click on ‘Submit’. To associate an existing File to a Product, the vendor must search for and select the Product to which it s desired to associate Files. The vendor then chooses an ‘Associate File’ feature and searches for the File(s). All matching Files will be displayed. The vendor then selects the one(s) to be associated with the Product and dicks the ‘Submit’ feature. The File(s) selected will be added to the list of ‘Files in this Product’. The vendor may also add a specific file to one or more Products by using an “Add To” menu item from the View File screen 1300.

Re-Identify Product

If for some reason the vendor needs to change the Product ID of a Product that already exists in the system 100, one can do so by selecting ‘Re-identify’ once one has selected a Product. The ‘Re-identify’ form prompts the user for a new Product ID.

Inactivate/Reactivate Product

The most common reason to inactivate a Product is that a vendor's company is retiring the product or product line. Inactivating the Product does not affect accounts that already have entitlements to the Product, although it does prevent new orders for Catalog Items that include the Product from granting new entitlements to the product. Inactive Products can be reactivated by clicking on ‘Reactivate’ once the user has selected the Product.

Where Used

A ‘Where Used’ function lets the vendor find all of the Catalog Items that include the particular Product. Clicking on ‘Where Used’ returns a list of the Catalog Items that use the particular Product. Clicking on the name of a Catalog Item within this list will take you to the View Catalog Item screen from which you can also manage the Catalog Item.

Copy

To create a new Product that is very similar to an existing one, the vendor can use the ‘Copy’ function on the Product menu. The ‘Copy’ function will take all of the attribute values of the original Product and copy them into the corresponding fields of a new ‘Create Product’ form. One can then make any changes necessary to distinguish the new Product from the original and then save the new Product.

Add To

An ‘Add To’ function allows the vendor to associate the particular Product with one or more Catalog Items. After clicking ‘Add To’, the vendor is presented with a Catalog Item Search screen 600. A wildcard search capability allows the vendor to search for and select Catalog Item(s) to add this Product to.

Use Where

In some cases the vendor may not want to explicitly select Catalog Items to associate the particular Product with. An alternative is to tell the system to use the Product wherever some other Product is already being used. That is, to associate the Product with all the Catalog Items with which another Product is associated. When the vendor clicks on ‘Use Where’, a ‘Product Search’ screen 900 is presented. The wildcard search capability allows the user to search for and select the Product(s) that will serve as the template for associating the particular Product with Catalog Items. Note that the ‘Use Where’ function will update all Catalog Items that contain the template Product unless the Catalog Item is a “non-Subscription” item. In order to associate a Product with a non-Subscription item the user must use the ‘Add To’ function.

Send Notification

A ‘Send Notification’ function allows the user to provide email text that will be sent to all users who have an entitlement that includes the particular Product. The vendor provides the subject line and the text of the email message.

File (FIG. 17)

Editing or Updating a File

‘Files’ are also searchable, as previously described for ‘Catalog Items’ and ‘Products’ b y way of the search Files user interface 1200.

Possible Search Criteria Include:

File ID;
System File ID
Short Description—The “name” of the file that the user sees.
File Status (Active, Inactive, or Both); and
File Name—Actual system level name of the file; for example, “installer_{—}2_{—}7.zip”.

Having searched for and selected a File the selected File is displayed in the view Files user interface 1300. After selecting a File, the vendor may:
Update the File information;
Upload a file (that is, upload the actual bits associated with the particular File object);
Find all the Products where this File is used (Where Used);
Add the file to one or more Products;
Inactivate/Reactivate the File; and
Instruct the system to use this File in all Products where some other File is used; for example, “use Widget_{—}2_l.ReadMe.txt wherever Widget_{—}2_l.exe is found”.
   Creating a File

Files are what the end user actually downloads. Files that are part of the same release are grouped together into one or more Products, that are in turn entitled through Catalog Items. Files are created by way of a user interface for editing or creating Files 1400. A ‘File’ may include any or all of the following vendor-definable attributes
File ID—A unique value by which the vendor identifies the particular file, for example an identifier from a release management or source code control system;
Short Description—The file name that the end user sees, ideally a brief but descriptive name, for example, “Enterprise Server 2.4 Solaris”;
Long description—Additional installation information or compatibility hints or to provide detailed information about the file content. Note that if the file provided is in a zip format then the user interface will automatically display the .zip file contents in addition to the information provided by the vendor;
File Sort Order—If numeric values are provided, then the files that are part of the particular Product will be sorted in ascending numeric order. If no sort order is specified or when more than one file has the same ‘File Sort Order’ number, the files will be sorted in alphabetical according to the ‘Short Description’;
Deliver File via (Upload/Other)—‘Upload’ allows the vendor to use a system ‘Upload Product Files’ feature to upload the file from a browser; and
Retrieve From—The vendor specifies the location of the image file. The most common methods of supplying the file are by uploading to the system server, providing a link to an ftp server, or sending CD's or some other removable medium. When a file is uploaded, this field is filled in automatically. If the file is to be provided from an FTP server, the vendor must provide a fully qualified path to the file. If the file is provided on removable media, information needed to load the file and correctly associate it with the product needs to be provided.

In addition to the vendor-supplied File ID, each File is assigned a unique system ID at time of creation.

Provided herein below is a more detailed description of File operations:

View File

The ‘View File’ screen 1300 is accessed either by searching for and selecting an existing File 1200 or by creating a new File 1400. The View File screen displays the current values for the particular File's attributes.

Update File Information

Once the vendor has selected a File, they can dick on ‘Update’ to edit and update the File attributes The ‘Update File’ form behaves much like the ‘Create File’ form and allows the vendor to modify all of the product information except the ‘File ID’. If the actual base file has been uploaded and is in the system then the vendor may also update the File Name.

Upload File

One can upload the actual system file to an existing File object by selecting ‘Upload File’ from the menu. An ‘Upload File’ form displays the details of the File object the file is being uploaded to. The vendor can either enter a file path (relative to the vendor's computer) or dick a ‘Browse’ button to open a system window which will allow the vendor to choose the file using the OS file manager. Clicking on ‘Submit’ uploads the file to the system.

Where Used

The ‘Where Used’ function allows the vendor to find all of the Products that include the particular File. Selecting ‘Where Used’ returns a list of the Products that use the File. Clicking on the name of a Product within this list will navigate the user to the ‘View Product’ screen 1000.

Add To

The ‘Add To’ function allows one to associate this File with one or more Products. After selecting ‘Add To’, a Product Search screen appears 900. The wildcard search capability allows the vendor to search for and select the Product(s) to add the File to.

Use Where

In some cases, the vendor may not want to explicitly select the Products to which they want the File associated. As an alternative one can tell the system to use this File wherever some other File is already being used. That is, associate this File with all the Products with which another after dicking ‘Use Where’, a ‘File Search’ screen appears. The wildcard search capability allows the vendor to search for and select the File(s) that will serve as the template for associating this File with Products. Note that the ‘Use Where’ function updates all Products that contain the template File unless the Product is a non-Subscription item. Associating a File with a non-Subscription item requires use of the ‘Add To’ function.

The product hierarchy may also include the following entities:
one or more product families;
one or more bundles; and
one or more product lines.

These additional product groupings are defined by way of a ‘Configuration’ user interface (not shown).

The foregoing listing of levels, objects and object attributes is meant only to be illustrative. Other hierarchies, levels, objects and object attributes may be envisioned by one having an ordinary level of skill in the art, and are entirely consistent with the spirit and scope of the invention.

Subscription and Non-Subscription Items

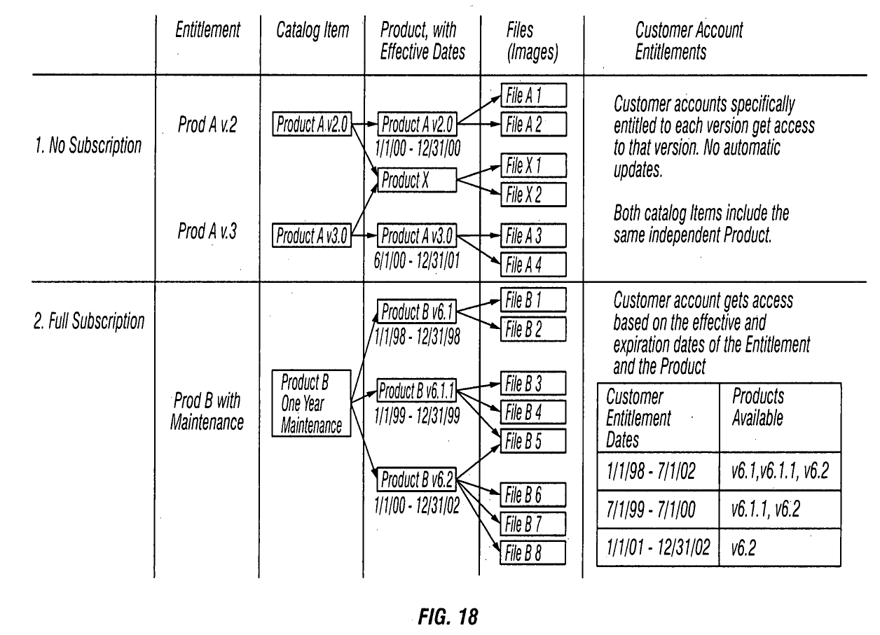

FIG. 18 shows a data flow diagram for 1) non-subscription and 2) subscription items.
Non-Subscription items—as shown, customer accounts specifically entitled to separate versions of a vendor's product, denoted by separate Catalog Items, are granted access only to that version; and
Subscription items—the customer account is granted access based on the effective and expiration dates of the Entitlement and the Product.
   Date Management

As previously described, an end user receives access to a vendor's product either: 1) through a new entitlement to a ‘Catalog Item’ that has one or more products associated with it, or 2) through a new ‘Product’ update to a subscription-based ‘Catalog Item’ to which the user was previously entitled.

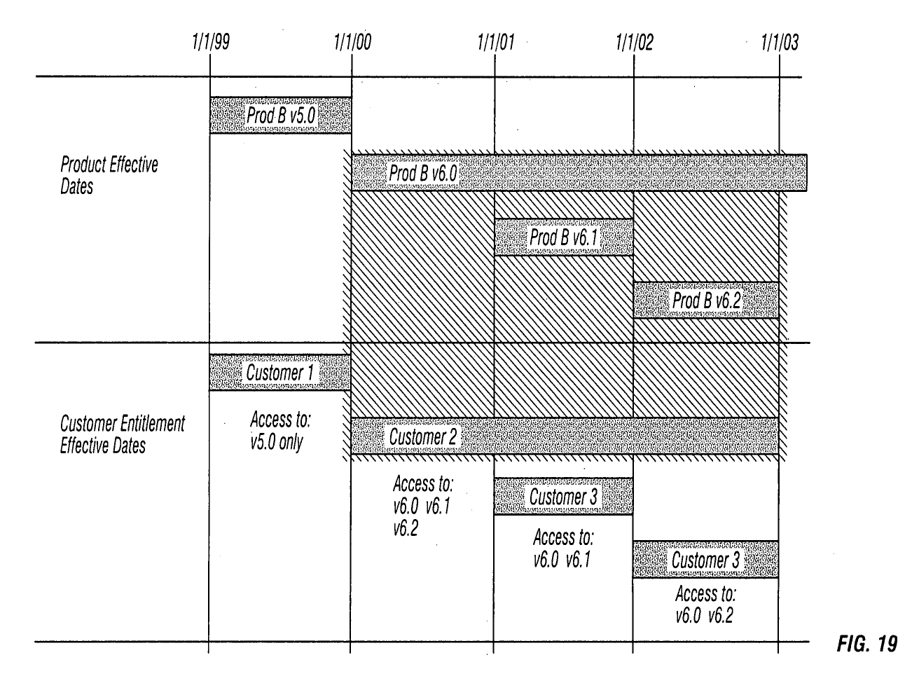

For subscription Catalog Items, the product selection the end user sees on the service site is determined by the effective dates defined for the Products and the effective period specified on the entitlement to the corresponding Catalog Item. The overlap window between the effective and expiration dates of the Product and of the Entitlement determine which products the end user is granted access to, as shown in FIG. 19.

The invention is implemented and practiced using conventional techniques known to those skilled in the art of computer programming. A number of common programming, scripting, and/or markup languages are suitable for implementation and practice of the invention.

Although the invention has been described herein with reference to certain preferred embodiments, one skilled in the art will readily appreciate that other applications may be substituted for those set forth herein without departing from the spirit and scope of the present invention. Accordingly, the invention should only be limited by the claims included below.

1. A method for managing digital goods, comprising steps of:
creating a product hierarchy for modeling and managing complex product relationships among a vendor's product and/or service offerings, wherein each product and/or service offering is represented as at least one primary object, and associations between primary objects any time said product and/or service offering is represented as more than one primary object;
creating customer account entitlements to said product and/or service offerings; and
distributing said product and/or service offerings to an end user according to said entitlements.

2. The method of claim 1, further comprising a step of:
implementing said method as a network-based service, said service provided by a system operator.

3. The method of claim 2, further comprising steps of:
providing said service to vendors on a subscription basis; and
providing each subscribing vendor a network presence.

4. The method of claim 3, said step of creating customer account entitlements to said product and/or service offerings comprises steps of:
transmitting orders to a central repository;
processing said orders at said central repository; and
managing customer accounts according to said orders.

5. The method of claim 4, wherein said step of transmitting orders to a central repository comprises a step of:
transmitting a data feed, wherein said data feed specifies which customers are being entitled to which product and/or service offerings.

6. The method of claim 3, wherein said network presence includes at least one tool for defining said primary objects and said associations.

7. The method of claim 3, said network presence including a user interface branded to said vendor, wherein said step of distributing said product offerings to an end user according to said entitlements comprises steps of:
providing to each customer account a personalized digital goods maintenance portal within said network presence;
displaying said product hierarchy as a navigable hierarchy, said navigable hierarchy displaying only product offerings to which said customer account is entitled; and
downloading by said end user one or more of said product and/or service offerings to which said customer account is entitled.

8. The method of claim 7, further comprising a step of providing said customer any of:
related software documentation;
access keys;
release notes; and
contact information.

9. The method of claim 7, further comprising a step of:
requiring said customer to read and accept an end-user license agreement.

10. The method of claim 7, further comprising a step of:
configuring said personalized portal by said customer.

11. The method of claim 3, further comprising a step of:
configuring said network presence by said vendor.

12. The method of claim 11, further comprising a step of notifying said customer that a product offering to which they are entitled is available wherein notification is made using e-mail messages.

13. The method of claim 12, wherein said e-mail messages are customized by said vendor.

14. The method of claim 1, wherein object types include any of:
said entitlements;
catalog items;
products; and
files.

15. The method of claim 14, wherein an entitlement comprises a customer account entitlement, said entitlement associated with one or more catalog items.

16. The method of claim 14, wherein a catalog item comprises a discrete product offering from said vendor, attributes of a catalog item including any of:
catalog item ID;
description;
type;
subscription;
temporary;
default duration;
default maximum down load limit;
catalog product line;
license group;
support agreement; and
user-defined field;
wherein said catalog item is associated with one or more products.

17. The method of claim 14, wherein catalog items comprise any of:
subscription catalog items; and
non-subscription catalog items.

18. The method of claim 17, further comprising steps of:
defining effective dates for products associated with a subscription catalog item;
specifiying an effective period for an entitlement to said subscription catalog item; and
providing said associated products during an overlap window between said effective dates and said effective period.

19. The method of claim 14, further comprising any of the steps of:
granting unlimited access to a catalog item indefinitely;
limiting duration of access to said catalog item; and
limiting number of downloads of files associated with a product.

20. The method of claim 14, wherein a product comprises a deliverable product release, attributes of a product comprising any of:
product ID;
description;
effective date;
expiration date;
export compliance classification
product manufacturer;
product line;
end user license agreement;
download instructions; and
physical distribution available;
wherein a product is associated with one or more files.

21. The method of claim 14, wherein files comprise actual data files that said entitled party downloads, attributes of a file including any of:
file ID;
description;
content detail; and
retrieve from location.

22. The method of claim 21, further comprising a step of uploading said files to a central repository.

23. The method of claim 21, further comprising a step of collating files included into a product into a single file, so that download and installation of said files is facilitated.

24. The method of claim 14, wherein said hierarchy further includes any of:
one or more product families;
one or more bundles; and
one or more product lines.

25. The method of claim 2, wherein said product and/or service offerings include any of:
said digital goods; and
service agreements.

26. A system for managing digital goods, comprising:
a product hierarchy for modeling and managing complex product relationships among a vendor's product and/or service offerings, wherein each product and/or service offering is represented as at least one primary object, and associations between primary objects any time said product and/or service offering is represented as more than one primary object;
means for creating customer account entitlements to said product and/or service offerings; and
means for distributing said product and/or service offerings to an end user according to said entitlements.

27. The system of claim 26, further comprising means for:
implementing said system as a network-based service, said service provided by a system operator.

28. The system of claim 27, further comprising means for:
providing said service to vendors on a subscription basis; and
providing each subscribing vendor a network presence.

29. The system of claim 28, said means for creating a customer account entitlements to said product and/or service offerings comprising means for:
transmitting orders to a central repository;
processing said orders at said central repository; and
managing customer accounts according to said orders.

30. The system of claim 29, wherein said means for transmitting orders to a central repository comprises means for:
transmitting a data feed, wherein said data feed specifies which customers are being entitled to which product and/or service offerings.

31. The system of claim 28, wherein said network presence includes at least one tool for defining said primary objects and said associations.

32. The system of claim 28, said network presence including a user interface branded to said vendor, wherein said means for distributing said product and/or service offerings to an end user according to said entitlements comprises means for:
providing to each customer account a personalized digital goods maintenance portal within said network presence;
displaying said product hierarchy as a navigable hierarchy, said navigable hierarchy displaying only product and/or service offerings to which said customer account is entitled; and
downloading by said end user one or more of said product and/or service offerings to which said customer account is entitled.

33. The system of claim 32, further comprising means for providing said customer any of:
related software documentation;
access keys;
release notes; and
contact information.

34. The system of claim 32, further comprising means for:
requiring said customer to read and accept an end-user license agreement.

35. The method of claim 32, further comprising means for:
configuring said personalized portal by said customer.

36. The system of claim 28, further comprising means for:
configuring said network presence by said vendor.

37. The system of claim 36, further comprising means for notifying said customer that a product and/or service offering to which they are entitled is available by means of email messages.

38. The system of claim 37, wherein said e-mail messages are customized by said vendor.

39. The system of claim 26, wherein object types include any of:
said entitlements;
catalog items;
products; and
files.

40. The system of claim 39, wherein an entitlement comprises a customer account entitlement, said entitlement associated with one or more catalog items.

41. The system of claim 39, wherein a catalog item comprises a discrete product and/or service offering from said vendor, attributes of a catalog item including any of:
catalog item ID;
description;
type;
subscription;
temporary;
default duration;
default maximum down load limit;
catalog product line;
license group;
support agreement; and
user-defined field.
wherein said catalog item is associated with one or more products.

42. The system of claim 39, wherein catalog items comprise any of:
subscription catalog items; and
non-subscription catalog items.

43. The system of claim 39, further comprising means for:
defining effective dates for Products associated with a subscription catalog item;
specifiying an effective period for an Entitlement to said subscription catalog item; and
providing said associated Products during an overlap window between said effective dates and said effective period.

44. The system of claim 39, further comprising means for:
granting unlimited access to a Catalog Item indefinitely;
limiting duration of access to said Catalog Item; and
limiting number of downloads of files associated with a Product.

45. The system of claim 39, wherein a Product comprises a deliverable product release, attributes of a product comprising any of:
product ID;
description;
effective date;
expiration date;
export compliance classification
product manufacturer;
product line;
end user license agreement;
download instructions; and
physical distribution available;
wherein a product is associated with one or more files.

46. The system of claim 39, wherein Files comprise actual data files that said entitled party downloads, attributes of a file including any of:
file ID;
description;
content detail; and
retrieve from location.

47. The system of claim 46, further comprising means for uploading said Files to a central repository.

48. The system of claim 46, further comprising means for collating Files included into a product into a single file, so that download and installation of said files is facilitated.

49. The system of claim 39, wherein said hierarchy further includes any of:
one or more product families;
one or more bundles; and
one or more product lines.

50. The system of claim 27, wherein said product and/or service offerings include any of:
said digital goods; and
service agreements.
